(19) United States
(12) Patent Application Publication
(10) Pub. No.: US 2006/0093861 A1
(43) Pub. Date: May 4, 2006

(54) Method for producing doped, alloyed, and mixed-phase magnesium boride films

(75) Inventors: Alexej Pogrebnyakov, State College, PA (US); Xiaoxing Xi, State College, PA (US); Joan M. Redwing, State College, PA (US); Qi Li, State College, PA (US)

Correspondence Address: MCDERMOTT WILL & EMERY LLP, 600 13TH STREET, N.W., WASHINGTON, DC, 20005-3096, US

(73) Assignee: THE PENN STATE RESEARCH FOUNDATION

(21) Appl. No.: 10/976,123

(22) Filed: Oct. 29, 2004

(51) Int. Cl. C01B 35/04; C01B 25/08; B32B 9/04

(52) U.S. Cl. 428/704; 423/289

(57) ABSTRACT

Conducting and superconducting doped, magnesium boride materials are formed by a process which combines physical vapor deposition with chemical vapor deposition by physically generating magnesium vapor in a deposition chamber and introducing a boron containing precursor and a dopant into the chamber which combines with the magnesium vapor to form the material. Embodiments include forming carbon-doped magnesium diboride film and powder with hybrid physical-chemical vapor deposition (HPCVD) by adding a carbon-containing metalorganic magnesium precursor, bis(methylcyclopentadienyl)magnesium, with a hydrogen carrier gas together with a borane precursor in a chamber having a source of magnesium vapor.

### RELATED APPLICATION

The present application contains subject matter similar to application Ser. No. 10/395,892 filed Mar. 25, 2003 and entitled “METHOD FOR PRODUCING BORIDE THIN FILMS”, now U.S. Pat. No. 6,797,341, the entire disclosure of which is hereby incorporated in its entirety herein by reference.

### FIELD OF THE INVENTION

The present invention relates to conducting and superconducting doped, alloyed, and mixed-phase magnesium boride materials and methods of their formation and, in particular, to carbon-doped, magnesium diboride films and powders for use in superconducting electronics such as superconducting integrated circuits, in conductor tapes and wires for generating high magnetic fields, and other applications using conducting and superconducting materials.

### BACKGROUND

Integrated circuits using superconductors are more suitable for ultrafast processing of digital information than semiconductor-based circuits. Niobium (Nb) based superconductor integrated circuits using rapid single flux quantum (RSFQ) logic have demonstrated the potential to operate at clock frequencies beyond 700 GHz. However, the Nb-based circuits must operate at temperatures close to 4.2 Kelvin (K), which requires heavy cryocoolers with several kilowatts of input power, which is not acceptable for most electronic applications. Circuits based on high temperature superconductors (HTS) would advance the field, but 18 years after their discovery, reproducible HTS Josephson junctions with sufficiently small variations in device parameters have proved elusive.

The success in HTS Josephson junctions has been very limited due to the short coherence length, about 1 nm, in the HTS materials.

The newly-discovered superconductor material, magnesium diboride (MgB₂), holds great promise for superconducting electronics, in part, because of its relatively high transition temperature (T_{c}), at which temperature the respective material becomes superconducting and changes in electrical resistance from a finite value to zero. This temperature for MgB₂, in bulk, can be as high as 39 K. Like the conventional superconductor Nb, MgB₂ is a phonon-mediated superconductor with a relatively long coherence length, about 5 nm. These properties make the prospect of fabricating reproducible uniform Josephson junctions more favorable for MgB₂ than for other high temperature superconductors. A MgB₂-based circuit can operate at about 25 K, achievable by a compact cryocooler with roughly one-tenth the mass and the power consumption of a 4.2 K cooler of the same cooling capacity. Furthermore, since the ultimate limit on device and circuit speed depends on the product of the junction critical current, I_{c}, and the junction normal-state resistance, Rₙ, and since I_{c}Rₙ, is proportional to the energy gap of the superconductor, the larger energy gap in MgB₂ could lead to even higher speeds (at very high values of critical current density) than in Nb-based superconductor integrated circuits.

Another area of applications for superconducting materials include electric power and high field magnets. The electric power applications further include cables, superconducting magnet energy storage devices, motors, generators, etc. High field magnets can be used in various medical devices such as MRI magnets, in addition to magnets for high energy accelerators, high magnetic field facilities, laboratory magnets, etc. For these type of applications, an important material property is the critical current density (Jc) and the upper critical field (H_{C2}).

The upper critical field is the ability of a superconductor to sustain superconductivity at higher magnetic fields. The upper critical field of magnesium diboride is a factor in using this material for electric power applications and high field magnetic applications because magnesium diboride exhibits high critical current densities, no intrinsic current blockage by grain boundaries, and comparatively weak anisotropy and thermal fluctuation. A high upper critical field and critical current density in the magnetic field make magnesium diboride a very attractive high field material. However, highly pure magnesium diboride films appear not to show a clear advantage compared to existing Nb-based high field superconductors because of the typically relatively low upper critical fields that are achieved with currently prepared undoped magnesium diboride films, such as in the form of wires and tapes, crystals, and bulk samples.

However, it is known that adding impurities and defects can increase the upper critical field of a superconductor. This has been applied to magnesium diboride wires and films with limited success. (See, e.g., R. H. T. Wilke et al., “Systematic effects of carbon doping on the superconducting properties of Mg(B₁₋ₓCx)₂,” Phys. Rev. Lett., vol. 92, pp. 217003, 2004. V. Braccini et al., “The development of very high upper critical field in alloyed MgB2 thin films,” to be published in Phys. Rev. B.)

Accordingly, a continuing need exists for the efficient manufacture of superconductors, in particular magnesium boride superconductors with controlled levels of impurities and defects, controlled microstructures, in high throughput, and with high critical current density and high upper critical field.

### BRIEF SUMMARY

Advantages of the present invention are magnesium boride conducting materials and methods for their manufacture.

Additional advantages and other features of the present invention will be set forth in the description which follows and in part will be apparent to those having ordinary skill in the art upon examination of the following or may be learned from the practice of the present invention. The advantages of the present invention may be realized and obtained as particularly pointed out in the appended claims.

According to the present invention, the foregoing and other advantages are achieved in part by a method which combines physical vapor deposition with chemical vapor deposition. The method includes physically generating magnesium vapor from at least one magnesium source material, which is within a chamber. The magnesium vapor of the source material can be physically generated by, for example, heating the source material, ablating the source material, or by employing a pulsed laser upon the source material thereby physically generating vapor of the source material in the chamber.

The method additionally includes introducing at least one boron containing precursor and a dopant to the chamber. The precursor and dopant combine with the magnesium vapor from the at least one magnesium source material to form a doped, magnesium boride material. Typically, the precursor, dopant and magnesium from the source material combine by chemical reaction, but the invention is not so limited. Physical combinations of the constituents are also contemplated. The combination of components in the chamber, chemically or physically, form a doped, magnesium boride that comprises the constituents of the precursor, e.g. boron as a boride, constituents of the dopant, e.g., carbon from a carbon-containing dopant, and magnesium from the source. The formed doped magnesium boride can be in the form of a film, powder, etc.

Embodiments of practicing the present invention include physically generating vapor from a magnesium source material including magnesium or an alloy thereof; introducing a boron containing precursor, e.g., a diborane or haloborane, to the chamber; introducing a carrier gas, e.g., hydrogen and/or nitrogen; introducing a magnesium metalorganic dopant, e.g., bis(methylcyclopentadienyl)magnesium, and forming a carbon-doped, alloyed, and mixed-phase, magnesium diboride film or powder within the chamber.

Another aspect of the present invention is a doped, magnesium boride film on a substrate suitable for use in electronic applications. In an embodiment of the present invention, a carbon-doped, magnesium diboride film having an upper critical field of at least 50 T at 4.2K.

Another aspect of the present invention is a doped, alloyed, and mixed-phase magnesium boride film on a substrate suitable for use as electric wires, tapes and cables. In an embodiment of the present invention, a carbon-doped, magnesium diboride coating is formed on a fiber, such as a SiC fiber. The structure can then be used to fabricate wires, tapes, cables, etc. Advantageously, the magnesium diboride coating has an upper critical field as high as that in a carbon-doped magnesium boride film on a single crystal substrate.

Additional advantages of the present invention will become readily apparent to those skilled in this art from the following detailed description wherein embodiments of the present invention are described simply by way of illustration of the best mode contemplated for carrying out the present invention. As will be realized, the present invention is capable of other and different embodiments, and its several details are capable of modifications in various obvious respects, all without departing from the present invention. Accordingly, the drawings and description are to be regarded as illustrative in nature, and not as restrictive.

### BRIEF DESCRIPTION OF THE DRAWINGS

The various features and advantages of the present invention will become more apparent and facilitated by reference to the accompanying drawings, submitted for purposes of illustration and not to limit the scope of the invention, where the same numerals represent like structure and wherein:

FIG. 1 Carbon content in the doped MgB₂ films, in the unit of the atomic percentage, as a function of the H₂ flow rate through a (MeCp)₂Mg bubbler, FR_{bubbler}. The line is a polynomial fit.

FIG. 2 (a) Resistivity vs temperature curves for MgB₂ films of different carbon doping. (b) Residual resistivity (closed circles) and Tc (open circles) as a function of carbon concentration for films plotted in (a). In (a), from bottom to top, the nominal carbon concentrations of the curves are 0, 7.4, 15, 22, 29, 34, 39, 42, and 45 at. %.

FIG. 3 (a) X-ray diffraction θ-2θ scans for MgB₂ films with carbon doping. From top to bottom, the nominal carbon concentrations are 0, 7.4, 15, 22, 28, 39, 42, and 45 at. %. The spectra are shifted vertically for clarity. The peaks labeled with an asterisk are due to the SiC substrate peaks. (b) The c-axis lattice constant (open triangles) and a-axis lattice constant (closed squares) of the carbon doped MgB₂ films as a function of nominal carbon concentration.

FIG. 4 Upper critical field as a function of temperature for an undoped film and two doped films with 7.4 at. % and 22 at. % nominal carbon concentrations, respectively. The closed symbols are for parallel field (H^{∥}c2) and the open symbols are for perpendicular field (H^{⊥}c2).

FIG. 5 Critical current density as a function of magnetic field (H^{∥}c) and temperature for (a) an undoped film and (b) a film doped with with 11 at. % nominal carbon concentration.

### DESCRIPTION OF THE INVENTION

The present invention contemplates forming doped, magnesium boride films by combining the techniques, in part, of a physical vapor deposition (PVD) process with that of a chemical vapor deposition (CVD) process. This hybrid physical chemical vapor deposition (HPCVD) process addresses various problems arising in fabricating magnesium boride, which often need high purity and morphological integrity for efficient superconducting properties and which are not readily achieved by either PVD or CVD individually.

In situ growth of magnesium boride films by HPCVD have been described in detail in U.S. Pat. No. 6,797,341, the entire disclosure of which is incorporated herein by reference. In general, the process comprises physically generating magnesium vapor from a magnesium source in a chamber such as by heating a susceptor holding the source material in a reaction chamber such as a vertical quartz reactor. A carrier can be introduced such as Hydrogen. When the susceptor is heated inductively to around 550-760° C., a high magnesium vapor pressure is generated. The introduction of a boron precursor causes the formation of magnesium boride materials such as in the form of a film or coating which can be deposited on to a substrate in the form of a fiber or otherwise.

As an example of forming a magnesium diboride film, 1000 ppm diborane (B₂H₆) in a carrier gas, such as hydrogen, can be introduced into the reactor with magnesium vapor causing the formation of a magnesium diboride film to grow on the substrate. The total pressure in the reactor during the deposition can be maintained at various pressures such as between 1-1,000 Torr (e.g., between about 1 to 700 Torr) but is generally held around 100 Torr. In one example, the flow rate of hydrogen carrier gas was maintained at 300 sccm and the flow rate of diborane was maintained at 150 sccm. The films were deposited on a 4H—SiC substrate at 720° C. and having a thickness of around 2000 Å.

In preparing doped, magnesium boride materials, a dopant is additionally introduced to the chamber. The dopant can be added simultaneous, before or after the introduction of the boron precursor. The dopant can be added as a single component or diluted with a solvent and/or carrier gas. The amount of dopant in the magnesium boride material can be low, as is typically used in doping semiconductors, and can be very high so as to form a mixed phased material or alloy. For example, the dopant concentration can be at the level of an impurity to 10, 20, 30, or 40 atomic percent or higher.

In practicing the present invention, any number of boron containing precursors can be used. Borides are a family of materials with many different functionalities. The HPCVD technique can be readily applied to the deposition of boride materials, and for the deposition of heterostructures of borides, which can lead to new multifunctional electronic devices. Examples of boron containing precursors include boranes and substituted boranes, such as diborane, boron trichloride, boron tribromide, boron trifluoride, trimethylboron, etc.

Additionally, any number of dopants can be used in practicing the present invention. In particular, carbon-containing dopants advantageously can be used to form carbon-doped, magnesium boride films. Examples of dopants include metalorganic compounds, hydrocarbons, such as methane, ethane, ethylene, propane, propylene, etc. oxygen, carbon-containing magnesium compounds, such as bis(methylcyclopentadienyl)magnesium, bis(cyclopentadienyl)magnesium, etc., boron compounds, such as trimethylboron, carbon halides, such as carbon tetrachloride, compounds containing aluminum, silicon, magnesium, lithium etc. These dopants can be introduced to the chamber concurrently with the boron precursor, or before, or afterward and can also be introduced to the chamber with a carrier gas to facilitate vaporization of the dopant.

The formation of doped, magnesium boride films can be achieved under essentially the same process as undoped magnesium boride films. Typically, a magnesium vapor is physically generated in a chamber and the other components introduced to combine with the magnesium vapor. The magnesium source can be heated to any appropriate temperature to thermally generate magnesium vapor. In one embodiment, the temperature is maintained between about 20° C. to 1200° C., e.g., from about 20° C. to about 900° C. A carrier gas, such as H₂, and a boron precursor can be introduced into the chamber simultaneously or individually and at different times from one another and at various flow rates. In one example, about 1000 ppm of B₂H₆ in H₂ are introduced to one port of the chamber as a gaseous mixture, and exhausted from another port of the chamber.

As an example, the procedures and conditions of forming undoped, MgB₂ films were as follows. The reactor is first purged with purified N₂ gas and purified H₂ gas for about 15 minutes each. The carrier gas during the deposition is 1 slm purified H₂ maintained at about 100 Torr. The susceptor, along with the substrate and Mg pieces, are then heated inductively to about 700-760° C. in the H₂ ambient. As the bulk Mg pieces are heated, most likely by both the sceptor and the induced current, to above 700° C., Mg vapor is generated. A B₂H₆/H₂ mixture is then introduced into the reactor to initiate growth of the material. When the B₂H₆ gas is not flowing through the reactor, there is no film deposition because of the low sticking coefficient of Mg at high temperatures. Once the B₂H₆ gas begins to flow, a MgB₂ film starts to grow on the substrate. The deposition rate depends on the B₂H₆ supply, and is about 3 Å/s for a B₂H₆ gas mixture flow rate of about 25 sccm. The film growth is terminated by switching off the B₂H₆ gas before the bulk Mg pieces are completely evaporated, which takes about 10 minutes. The sample is then cooled in the H₂ carrier gas to room temperature in about 5-6 minutes.

In an embodiment of the present invention, carbon-doped MgB₂ films can be grown in situ by the HPCVD technique. As an example, films were deposited on (0001) 4H—SiC substrates at 720° C. The thickness of the films was around 2000 Å. In the standard HPCVD deposition, because of the highly reducing H₂ ambient during the deposition and the high purity sources of Mg and B (from B₂H₆), very clean MgB₂ thin films are produced with a residual resistivity above Tc as low as 0.26 μg cm. For carbon doping a carbon containing dopant, e.g. a metalorganic magnesium such as bis(methylcyclopentadienyl)magnesium ((MeCp)₂Mg), can be added to the H₂ carrier gas. As an example, a secondary hydrogen flow was passed through a (MeCp)₂Mg bubbler which was held at about 760 Torr and about 21.6° C. as a source of the carbon containing dopant to the chamber. Under such conditions (MeCp)₂Mg is in the liquid form, and no additional heating of the transfer line is necessary. The secondary hydrogen flow, which contained (MeCp)₂Mg, was combined with the primary hydrogen flow in the reactor to a total of 700 sccm hydrogen flow. The flow of the boron precursor gas, about 1% diborane (B₂H₆) in H₂, was maintained at around 15 sccm. In this example, the amount of carbon doping depends on the flow rate of the secondary hydrogen gas flow through the (MeCp)₂Mg bubbler, FR_{bubbler}, which was varied between about 25 and 200 sccm to vary the flow rate of (MeCp)₂Mg into the reactor from about 0.0065 to 0.052 sccm. The total pressure in the reactor during the deposition was about 100 Torr.

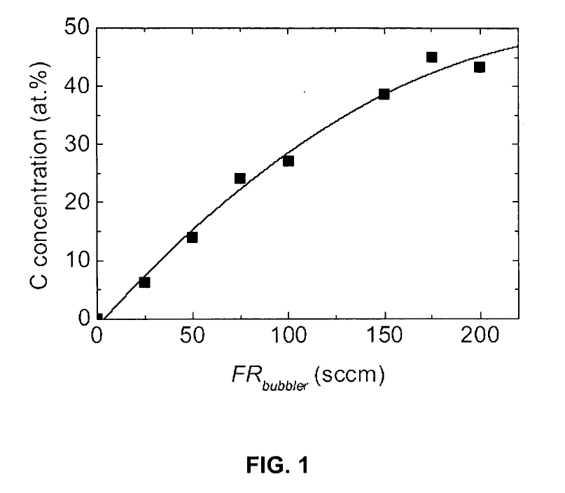

The carbon concentration in the films can be controlled easily by the secondary hydrogen flow rates through the (MeCp)₂Mg bubbler. A correlation between the carbon concentration and FR_{bubbler} was established, from which the carbon concentration for each film was derived. The chemical compositions of a series of carbon-doped MgB₂ films were measured by wavelength dispersive X-ray spectroscopy (WDS). The result is plotted in FIG. 1, and the line is a polynomial fit of the dependence of the carbon concentration on FR_{bubbler}. The scale of the carbon concentrations here is much higher than those in carbon-doped Mg(B1-_{χ}C_{χ})₂ single crystals and filaments. As discussed further it is believed that only a small portion of the carbon in the films is doped into the MgB₂ structure. The carbon concentrations determined by WDS result from carbon both in the Mg(B_{1-Ω}C_{χ})₂ grains and in the grain boundaries. Although it is difficult to determine the exact carbon concentrations in the Mg(B₁₋ₓCₓ)₂ grains, the nominal atomic concentrations determined by WDS can be used as a good indicator of the properties of the carbon-doped MgB₂ films produced by the HPCVD technique described here. Using the correlation shown in FIG. 1, for example, for a film made with FR_{bubbler}=125 sccm, a 34 atomic percent (at. %) as its nominal carbon concentration is used.

It was shown previously by cross-sectional transmission electron microscopy (TEM) that the carbon-doped MgB₂ films have a granular structure. (A. V. Pogrebnyakov et al., Appl. Phys. Lett. 85, 2017 (2004), which is hereby incorporated herein in its entirety herein by reference. They consist of columnar nano-grains of Mg(B₁₁-xC)₂ with a preferential c-axis orientation and an equiaxial in-plane morphology, and an amorphous phase between the grains. Combined with the transport and superconducting properties of these films, it was concluded that most likely a small portion of carbon is doped into MgB₂ and the rest is contained in the amorphous grain boundaries. The films were further characterized using a four-circle x-ray diffractometer equipped with both 2-dimensional area detector and four-bounce monochromator. The 0-20 scans show that the MgB₂ 00 l peaks are suppressed gradually as carbon concentration increases, and dramatically when the carbon concentration is above about 30 at. %. Both the c and a axes expand until about 30 at. %, above which the c lattice constant decreases and the a lattice constant increases dramatically. The doping dependence of the lattice constants is qualitatively different from those in carbon-doped single crystals and filaments, where the a axis lattice constant decreases but that of c-axis remains almost constant for all the carbon concentrations.

The use of the 2-dimensional area detector, which is capable of capturing a large slice of the Ewald Sphere at constant φ, resulting in an image with axes of 2θ and χ, allows the detection of the impurity phases. These secondary phases are commonly missed in conventional point detector scans, but can easily be identified in this analysis due to the detector's wide detection angle and extreme sensitivity. The intensity of the individual image in the 2θ/χ scans are then integrated in χ and combined with images taken at different φ angles to produce pole figures. The first image showed an undoped epitaxial film on a 0001 oriented SiC substrate. The peaks following a pin-wheel pattern are of 10 l SiC. The MgB2 101 reflections was seen adjacent to the SiC 104 peaks. From a carbon-doped MgB₂ film with a nominal carbon concentration of 29 at. %, peaks from the secondary phases was seen. The MgB₂ peaks exhibited the same six-fold symmetry and texture with respect to χ as the undoped films, but were slightly dimmer. The identity of the impurity phases were attempted by cross-referencing the d-spacings of the peaks with the χ and φ values at which they appear. Although a definitive identification was not possible, it was concluded that they are most likely B₄C, B₈C, or B₁₃C₂. The four-fold symmetric axis of the phase, which is clearly shown in the pole figure, is not collinear with the c-axis of the film. It was not possible to conclude from the x-ray analysis whether the phase exists within the boundary regions or it is incorporated into the MgB₂ grains.

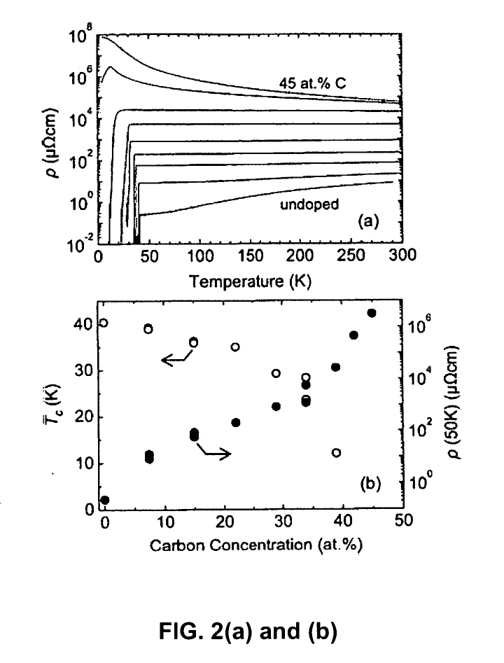

The resistivity (in log scale) versus temperature curves for MgB₂ films with different carbon doping levels are shown in FIG. 2(a). The carbon doping causes a dramatic increase in the resistivity, whereas the Tc of the film is suppressed much more slowly. For example, with a carbon concentration of 24 at. %, the residual resistivity increases from the undoped value of less than 1 μΩcm to about 200 μΩcm, but Tc only decreases from over 41 K to 35 K. The dependencies of residual resistivity and Tc on the carbon concentration in the doped MgB₂ films are plotted in FIG. 2(b). Tc is suppressed to below 4.2 K at a nominal carbon concentration of 42 at. % when the residual resistivity is 440 mΩcm. This is very different from those in carbon-doped single crystals, where Tc is suppressed to 2.5 K at a residual resistivity of 50 μΩcm when 12.5 at. % of carbon is doped into MgB₂. This discrepancy indicates that only a small portion of the carbon in the films is doped into the MgB₂ structure and the rest most likely forms high resistance grain boundaries giving rise to poor connectivity of the Mg(B₁-xCx)₂ grains.

The granular structure of the carbon-doped MgB₂ films was confirmed by TEM. A cross-sectional TEM image of a film with 22 at. % nominal carbon concentration was taken along the [110] direction of a silicon carbide substrate. It showed that the film consists of columnar nano-grains (the contrast changes laterally, but not vertically) of Mg(B₁-xCx)₂ with a preferential c-axis orientation. The selected area electron diffraction pattern taken from the MgB₂/SiC interface area showed two types of features, diffraction spots and arcs. The spots belong to the single crystal SiC substrate (SC) and the arcs to the MgB₂ film (MB). The arcs consist of many fine spots originating from individual columnar grains which showed a deviation of their c axis from the film normal. A more detailed description of the x-ray crystallography data for carbon doped MgB₂ films can be found in Pogrbnyakov et al. “Properties of MgB₂ Thin Films with Carbon Doping” Applied Physics Let. (2004) 85:2017-2019, the entire disclosure of which is hereby incorporated herein by reference.

In the planar-view image, the change of contrast indicated an equiaxial in-plane morphology of the columnar grains, and an amorphous phase was also observed between the grains. The composition of the amorphous areas was not readily determined, but it was believed most likely that the large portion of carbon that was not doped into MgB₂ was contained in these areas. A typical diffraction pattern taken along the film normal showed a strong hexagonaldistributed spots which in turn showed that the hexagonal-on-hexagonal inplane relationship between the columnar grains and SiC dominates, while the diffraction rings reveal grains that are randomly in-plane oriented.

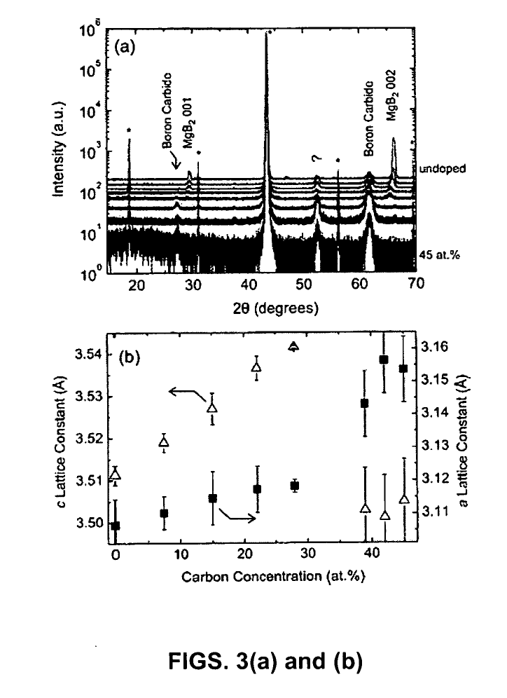

FIG. 3 shows θ-2θ scans of an undoped MgB₂ film and films doped with different amounts of carbon. Compared to the undoped films, the MgB₂ 00 l peaks are suppressed as carbon concentration increases, and dramatically when the carbon concentration is above about 30 at. %. Meanwhile, as shown in FIG. 3(b), both the c and a axes expand until about 30 at. %, above which the c lattice constant decreases and the a lattice constant increases dramatically. This behavior is different from that in carbon-doped single crystals, where the a axis lattice constant decreases but that of c axis remains almost constant for all the carbon concentration. The peak marked by “?” is likely 101 MgB₂, the most intense diffraction peak of MgB₂. It becomes stronger as the carbon concentration increases, indicating an increased presence of randomly oriented MgB₂. The peaks marked by “boron carbide,” according to extensive pole figure analysis, are most likely due to B₄C, B₈C, or B₁₃C₂. Their intensities also increase with carbon concentration. From the TEM and x-ray diffraction results, we conclude that below about 30 at. %, a small portion of carbon is doped into the Mg(B₁-xCx)₂ columnar, c-axis-oriented nano-grains, and the rest goes into the grain boundaries consisting of highly resistive amorphous phases or boron carbides. Above about 30 at. %, the Mg(B₁-xCx)₂ nano-grains are completely separated from each other by highly resistive phases, become more randomly oriented, and their lattice constants relax. This is consistent with the result in FIG. 2(b).

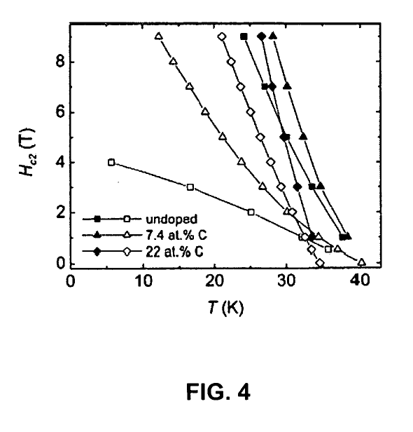

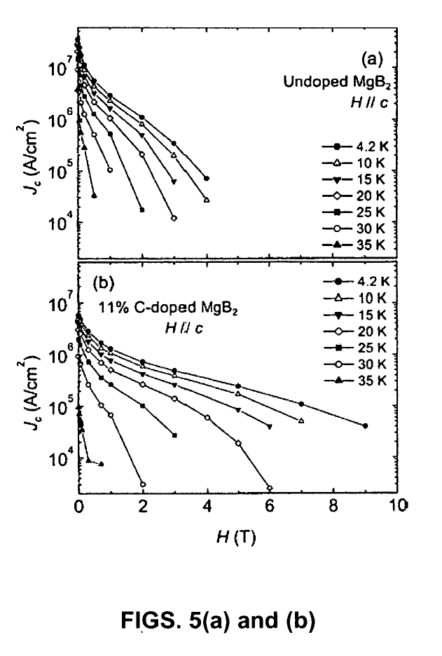

The upper critical field H_{c2} was measured using a Quantum Design PPMS system with a 9 T superconducting magnet. FIG. 4 shows the results for an undoped, 7.4 at. %, and 22 at. % carbon doped films. The value of H_{c2} is defined by 50% of the normal-state resistance R(H_{c2})=0.5R(Tc). It can be clearly seen that carbon doping changes the downward curvature in (H^{⊥}_{c2})(T) for the undoped film to an upward curvature in the carbon doped films. Both the slope, dH_{c2}/dT, near Tc and the low temperature H_{c2} increase with carbon concentration. It is believed that in high magnetic field measurements that carbon-doped MgB₂ films as described here have extraordinary H_{c2}(0) values as high as 70 T. The transport Jc(H) at different temperatures, determined by a 1 μV criterion from 20-50 μm bridges, for an undoped and a carbon doped MgB₂ film are shown in FIG. 5. While the undoped film has high self-field critical current densities, they are suppressed quickly by magnetic field due to the weak pinning. For the film doped with 11 at. % nominal carbon concentration, Jc values are relatively high in much higher magnetic fields. This indicates a significantly enhanced vortex pinning in carbon doped MgB2 films.

Carbon-doped MgB₂ thin films were deposited by HPCVD by adding (MeCp)2Mg to the carrier gas. The degree of carbon doping can be easily controlled by the secondary H₂ flow rate through the (MeCp)₂Mg bubbler. By this process, only a small portion of carbon is doped into MgB₂ and the rest is contained in the highly resistive amorphous grain boundaries. As the carbon doping increases, the high resistivity grain boundaries gradually reduces the cross section of the conduction path between the Mg(B₁₋ₓCx)2 grains, leading to a rapid increase in the resistivity but a much slower decrease in Tc. The carbon doping significantly enhances H_{c2}, and the reduced conduction area also negatively impacts Jc. The technique of carbon doping in HPCVD films produces MgB₂ materials that are can be used for high magnetic-field applications.

The present invention enjoys industrial applicability in manufacturing various types of thin films, particularly thin films of conducting and superconducting materials for microelectronics efficiently and substantially free of oxide impurities and in a process that improves the conductivity properties of the material.

In the preceding detailed description, the present invention is described with reference to specifically exemplary embodiments thereof. It will, however, be evident that various modifications and changes may be made thereto without departing from the broader spirit and scope of the present invention, as set forth in the claims. The specification and drawings are, accordingly, to be regarded as illustrative and not restrictive. It is understood that the present invention is capable of using various other combinations and environments and is capable of changes or modifications within the scope of the inventive concept as expressed herein.

What is claimed is:

1. A method of forming a doped, magnesium boride, the method comprising:
physically generating magnesium vapor from at least one magnesium source material, which is within a chamber;
introducing at least one boron precursor to the chamber; and
introducing a dopant to the chamber to form a doped, magnesium boride material.

2. The method of claim 1, comprising introducing a carrier gas to the chamber prior to, during, or after introducing the precursor.

3. The method of claim 2, wherein the carrier gas contains hydrogen or nitrogen.

4. The method of claim 1, wherein the dopant is a metalorganic.

5. The method of claim 2, comprising maintaining a pressure of about 1 to about 700 Torr in the chamber during formation of the material.

6. The method of claim 2, comprising heating the at least one source material to a temperature of about 20° C. to about 1200° C. to physically generate the magnesium vapor from the at least one magnesium source material.

7. The method of claim 1, comprising forming the doped, magnesium boride material in the form of a fiber, a wire, or a tape.

8. The method of claim 1, comprising forming a alloyed or mixed phased magnesium boride material as the doped, magnesium boride material.

9. The method of claim 1, wherein the boron containing precursor is boron trichloride, boron tribromide, diborane, trimethylboron, boron trifluoride, or any combination thereof.

10. The method of claim 1, wherein the dopant is selected from the group consisting of organometallic magnesium compounds, bis(methylcyclopentadienyl)magnesium, bis(cyclopentadienyl)magnesium, boron compounds, trimethyl boron, carbon halides, carbon tetrachloride, hydrocarbons, methane, ethane, and propane, oxygen and compounds containing, aluminum, silicon, manganese, and lithium.

11. The method of claim 1, comprising maintaining a pressure of 1 to 1,000 Torr in the chamber during formation of the material.

12. The method of claim 1, comprising heating the at least one source material to a temperature of 20° C. to 1200° C. to physically generate the magnesium vapor.

13. The method of claim 1, comprising:
introducing diborane to the chamber as the precursor with a hydrogen carrier gas;
introducing bis(methylcyclopentadienyl)magnesium as the dopant with a hydrogen carrier gas; and
forming a carbon-doped magnesium diboride as the doped, magnesium boride material.

14. A method of forming a carbon-doped, magnesium boride, the method comprising:
physically generating magnesium vapor from at least one magnesium source material, which is within a chamber;
introducing at least one boron precursor to the chamber; and
introducing a carbon-containing dopant to the chamber to form a carbon-doped, magnesium boride material.

15. The method of claim 14, comprising
introducing diborane to the chamber as the boron precursor with a hydrogen carrier gas;
introducing bis(methylcyclopentadienyl)magnesium as the carbon-containing dopant to the chamber; and
forming a carbon-doped, magnesium diboride as the doped, magnesium boride material.

16. The carbon-doped magnesium diboride material formed from the method of claim 15.

17. The carbon-doped magnesium diboride material formed from the method of claim 15, wherein the material has an upper critical field of at least 50 T at 4.2 K.

18. A multilayered structure comprising the doped, magnesium boride material of claim 1 and a substrate.

19. A multilayered structure comprising the doped, magnesium boride material of claim 14 and a substrate.
